(19) United States
(12) Patent Application Publication
(10) Pub. No.: US 2007/0065788 A1
(43) Pub. Date: Mar. 22, 2007

(54) Method for developing a curriculum

(75) Inventors: Barry J. Davis, Minneapolis, MN (US); Mark G. Scullard, St. Louis Park, MN (US); Susanne C. Kukkonen, St. Paul, MN (US); Jeffrey L. Sugerman, Minneapolis, MN (US)

Correspondence Address: Stuart R. Hemphill, Esq.;DORSEY & WHITNEY LLP, Intellectual Property Department, 50 South Sixth Street, Suite 1500, Minneapolis, MN, 55402-1498, US

(73) Assignee: Inscape Publishing, Inc.

(21) Appl. No.: 11/231,163

(22) Filed: Sep. 20, 2005

(51) Int. Cl. G09B 19/00

(52) U.S. Cl. 434/236

(57) ABSTRACT

A method for developing a training curriculum from a pre-existing library of materials is provided. The method comprises: controlling selection of at least one set-up module from the pre-existing library; controlling selection of at least one closing module from the pre-existing library; and controlling selection of at least one insight module from the pre-existing library, wherein each insight module is sequence independent of the others. The method further comprises combining the set-up, closing and insight modules into a predefined set of learning materials.

### CROSS-REFERENCE TO RELATED APPLICATION(S)

None

### FIELD OF THE INVENTION

The present invention relates to a method for developing a curriculum, and more particularly, relates to a method for developing learning materials for training and development based on psychological understanding of interpersonal relationships and personal effectiveness.

### BACKGROUND OF THE INVENTION

The practice of accelerating the development of interpersonal awareness and effectiveness through a process of managed discovery is well established. Such interpersonal learning and development is applicable in leadership, management, communication skills, teamwork, and other forms of training applications commonly employed by organizations of all types. The managed discovery of personal and inter-personal insights are often aided through the use of psychological constructs and theories. A properly validated psychological theory can be a powerful learning tool, if it is accurately translated into a particular training application. Computer-based and print or recording based training, as well as instructor-led training classes, have been used successfully for many years as a way to train people on a variety of topics using such managed discovery, sometimes using an assessment instrument to determine the psychological profile of the trainees.

Existing training materials and systems are generally monolithic and linear, even when labeled as modular. They anticipate a specific learning objective and require a concerted effort to repurpose for alternative applications. The author/publisher or facilitator typically needs to make revisions to an existing set of materials to make them effective for a different purpose. This can be labor intensive and deters the creation of new learning materials designed to meet the particular needs of an individual or group of people.

Most learning materials are prepared for a particular application, such as workplace conflict, management or sales, and often for particular topic areas within that application, such as managing conflict within teams or conflict reduction in specific environments. However, many facilitators are asked for or desire to offer training or learning materials tailored to specific issues in a specific workplace or other environment. To meet such requests, facilitators either start from scratch to prepare their materials or, more likely, begin an editing and research process, by which they find materials in their inventory and seek to adapt them to the new application. Often new material must be located by research and worked into pre-existing material that is being edited. Sometimes permissions must be sought, if the desired new material is owned by others and will be used directly.

Preparing the design of and materials for the new application becomes time-consuming and requires authoring, research and economic resources. Even for those with a masterly grasp of the relevant psychological theories and their application to a training area, preparing effective new materials is significant work. This is particularly true if the facilitator desires to use visual or audiovisual presentation materials and tangible materials for distribution to participants that are well-produced. For facilitators with less experience, training and production resources, producing new seminar materials can be difficult and may result in ineffective materials that do not satisfy the training client's needs. The materials may not be properly connected to the relevant psychological constructs and theories and/or they may be ineffective in communicating the theory and its applications.

Therefore, there is a need in the art for a method that facilitates the efficient creation of course designs and learning materials that are based on psychological insights.

### BRIEF SUMMARY OF THE INVENTION

In one embodiment, the present invention provides a method for developing a training curriculum from a pre-existing library of materials. The method comprises: controlling selection of at least one set-up module from the pre-existing library; controlling selection of at least one closing module from the pre-existing library; controlling selection of at least one insight module from the pre-existing library, wherein each insight module is sequence independent of the others; and combining the set-up, closing and insight modules into a predefined set of learning materials.

In another embodiment, the invention provides a system for developing a training curriculum from a pre-existing library of materials, comprising: a software component for controlling selection of at least one set-up module from the pre-existing library; a software component for controlling selection of at least one closing module from the pre-existing library; a software component for controlling selection of at least one insight module from the pre-existing library, wherein each insight module is sequence independent of the others; and a software component for combining the set-up, closing and insight modules into a predefined set of learning materials.

### BRIEF DESCRIPTION OF THE DRAWINGS

The detailed description will refer to the following drawings, wherein like numerals refer to like elements, and wherein:

FIG. 1 is a block diagram illustrating one embodiment of a computer system in accordance with the present invention.

FIG. 2 is a block diagram illustrating one embodiment of a main library in accordance with the present invention.

FIG. 3 is a block diagram illustrating one embodiment of a content modules library in accordance with the present invention.

FIG. 4 is a block diagram illustrating one embodiment of an insight modules library in accordance with the present invention.

FIG. 5 is a block diagram illustrating one embodiment of a course outlines library in accordance with the present invention.

FIG. 6 is one embodiment of an adapting to different styles outline in accordance with the present invention.

FIG. 7 is a flowchart illustrating one embodiment of a method of developing a curriculum in accordance with the present invention.

FIG. 8 is a block diagram illustrating one embodiment of software components for a system in accordance with the present invention.

### DETAILED DESCRIPTION OF THE INVENTION

Overview. The present method and system has as one starting point the wide acceptance of certain psychological and/or behavioral theories as useful frameworks for a variety of training applications. Such theories include those associated with the Cattell 16 Personality Factor Questionnaire (developed by Raymond Cattell in the 1940s), the Myers-Briggs Type Indicator (based on the theoretical work of Carl Jung) and the DISC profile (based on the work on William Marston starting in the 1920s). There exist many learning materials that use these theories to a greater or lesser degree and with varying degrees of scientific rigor. In such materials there is a need to introduce the theory or the applicable portions of it and then to explain how the theory can be used to analyze situations and persons and develop particular strategies and plans useful to the particular training application. The broad applicability of the theory means that portions of it will recur both as theory and as the ideas and concepts underlying one or more topics in a particular application. The present invention arises in part from the recognition that the recurring relevance of certain theoretical constructs and certain applications of these makes it possible to define systematically course content modules and to author learning materials that, with appropriate selection and little or no adjustment, can be used for seminars for, a wide variety of training applications. Moreover, the present invention arises from a desire to provide facilitators guidance and tools that help maintain consistency with validated psychological theories in adapting them to particular applications. It is valuable both to author/publishers of learning materials and to the facilitators who use them to have flexible tools for rapid development of materials and to have those tools effectively control quality of the resulting materials.

To accomplish this, the present system and method provides a flexible and versatile set of tools that guide a facilitator in designing a course and in preparing the learning materials for its delivery. The materials needed typically include: (a) facilitator materials that will be used to guide the verbal presentation and/or to provide visual material that is delivered on a screen, such as slides and audiovisual content; and (b) participant deliverables, i.e., handouts that are provided to training participants for use during the course (e.g., activities guides) and/or thereafter (e.g., reports, planners).The materials may also include assessment tools of several kinds that are designed to develop information about the psychological attributes of seminar participants. The learning materials may be used for a “live” seminar with a facilitator or for computer-based training or individualized learning with printed and/or pre-recorded materials, with little or no facilitator participation. Different versions and publication formats can provide the same content for delivery in different training contexts.

The present system and method uses a main library that comprises multiple sub-libraries, for example, sub-libraries containing multimedia, course outlines, group activities and insight modules that focus on a variety of topics and have varying objectives. To increase versatility, certain library components are designed to be sequence independent and adjustable so that when a user desires a combination of multiple components from the various libraries to make a course, the user is not required to make changes to the components in order to bring together a set of learning materials that will be coherent and effective. The following description focuses on learning materials that develop and use psychological profiles of individuals and groups, but shows a method usable for other topics taught by facilitators. Also, the method may be implemented in either an electronic or paper/tangible materials (hard copy) form. A computer system is described that is suitable for efficient implementation. This system may be used to generate a hard copy of components that the user may select from and assemble into a learning materials package suitable for facilitator use and another materials package for participants (often a subset of the facilitator's package). Sets of learning materials for self-teaching may also be prepared. Alternatively, the learning materials may be assembled by computer selection to produce an electronic file with all components. Any necessary hard copies can be generated from this file.

By way of example, the following description contemplates a curriculum and learning materials based on DISC theory, in particular, the version of that theory that has been developed by Inscape Publishing, Inc. of Minneapolis, Minn. and its predecessor, Carlson Learning Company. It will be recognized that the systems and methods described apply to other versions of DISC and other psychological or behavioral theories that are used in training.

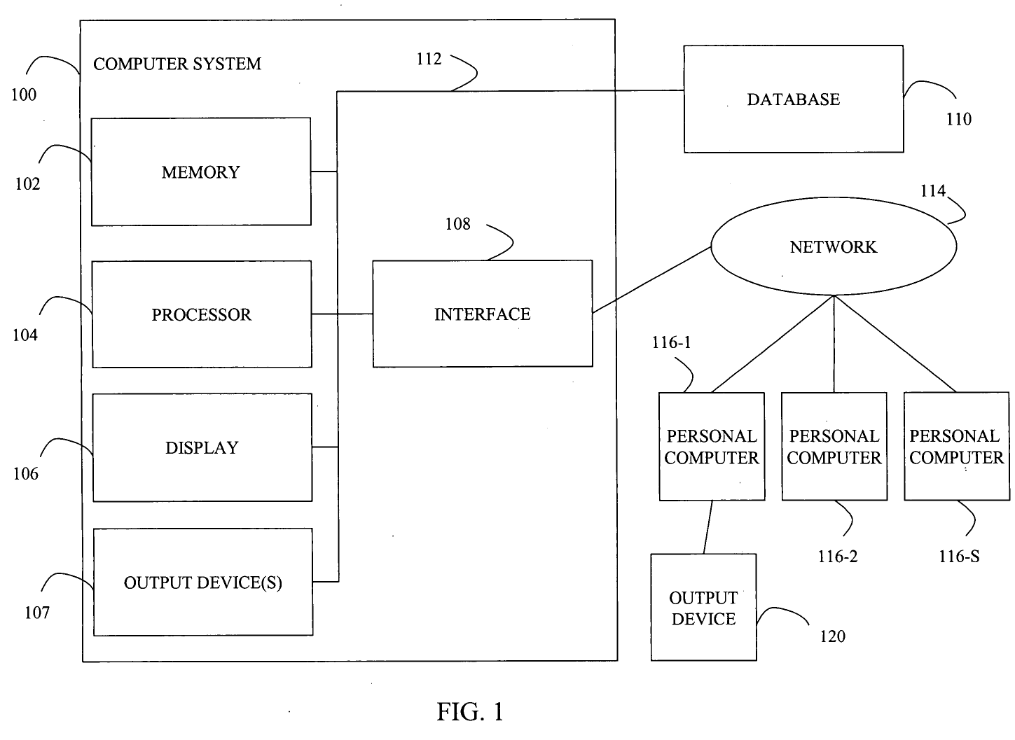

Computer System. FIG. 1 is a block diagram illustrating the basic arrangement of a computer system that may be used to implement the system and method for developing learning materials in accordance with the present invention. A computer system 100 comprises a memory 102, a processor 104, a display 106, output device(s) 107, an interface 108, and a system bus 112. The memory 102, processor 104, display 106, output device(s) 107 and interface 108 are connected to each other via the bus 112. The computer system 100 is adapted to communicate with a database 110. The database 110 and the memory 102 are adapted to store computer software applications with multiple components embodying the present invention. The database 110 and the memory 102 are also adapted to store data files containing the components for seminar materials used in the present invention.

In one embodiment, the database 110 is built using SQL Server and Microsoft Visual Studio, which uses XML. XML used directly or indirectly aids in making flexible the forms of output in which the database content may be published. These forms may include both paper and electronic files, depending on the nature of the output device(s) 107 (e.g., printers, CD burners, etc.)

The computer system 100 is connected to a network 114 via the communication interface 108. Examples of network 114 include but are not limited to the Internet, intranets, local area networks (LANs), wide area networks (WANs) or other suitable networks known by those skilled in the art. The network 114 is connected to computers 116-1, 116-2 to 116-S (only three are shown but any number may be connected). This allows computer system 100 to communicate with computers 116-1, 116-2 to 116-S, and allows computers 116-1, 116-2 to 116-S to access information contained in computer system 100. Access to the computer software applications and various portions of the data files may be used by authors/publishers/facilitators who seek to design courses and make materials for them and may be used by trainees to access assessments or other materials used in or in association with a course. The network 114 may also be used as the communications infrastructure for assessment administration, course enrollment, certification of completion and other tasks for managing training and development courses,

Personal computer 116-1 shows a connected output device 120 (available also on other personal computers 116 but for simplicity shown only on this one). Both this output device 120 and output device(s) 107 may be used to create electronic copies (e.g., CD) or hard copy items (e.g., paper) that can serve as learning materials or masters from which learning materials can be made.

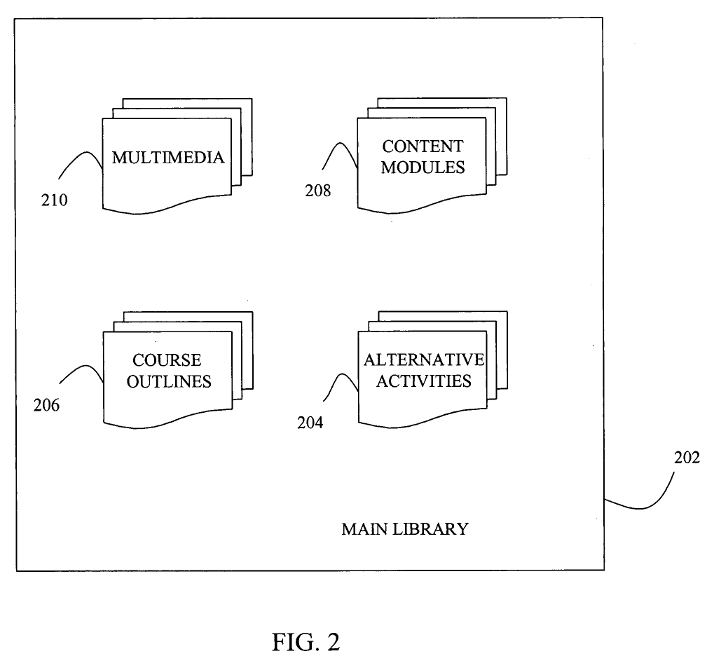

Libraries. FIG. 2 is a block diagram illustrating a main curriculum library 202 that is adapted to be stored in the database 110 and/or memory 102 of FIG. 1. Main library 202 comprises an alternative activities library 204, a course outline library 206, a content modules library 208, and a multimedia library 210. Course outlines library 206 includes multiple pre-made outlines for specific applications and is described in greater detail below. Content modules library 208 contains educational materials that are derived from the DISC theory and provide content from the facilitator and/or trainee viewpoint on particular subjects. These have some characteristics that make them highly versatile, and they are also described in greater detail below. The multimedia library 210 includes but is not limited to audiovisual works, PowerPoint® slides, self-paced tutorials, sample reports of educational products, handouts, and other types of multimedia. Multimedia materials are generally linked to content modules and used primarily directly as presentation content to trainees in a course. The alternative activities library 204 is generally linked to content modules and includes but is not limited to icebreakers, scripted interactions and other group activities. Alternative activities are used to supplement or replace portions of the content materials and provide opportunities for using different activities than the ones suggested in the educational materials found in the content modules library 208.

Components from these libraries provide the building blocks for learning materials for many applications. As will be seen, one or more sets of these components are authored so that they address discrete elements of the DISC theory and/or its application and thus are sequence independent. This is accomplished by partitioning the accepted and validated body of material developed for DISC courses so that the content unit or module is useful standing alone and without any prerequisite from other portions of the theory. Such components are more easily used in combination with other, like modules. They can be selected on the basis of their learning utility to an application, without other constraints. (The same approach can be used for courses based on other personal and interpersonal development theories, where human behavioral insights can be defined to be elemental and non-sequential and where separate psychological constructs can be identified and tested empirically.) The present invention uses the subdivision of learning materials by these elemental personal and inter-personal insight modules to provide a significant advantage over training materials that are developed and organized by application. Specifically, this method and process for subdividing insights without regard to application or sequence allows them to be assembled in a large number of permutations based on a given learning objective and specific needs. Thus, highly tailored learning programs can be assembled with minimal effort.

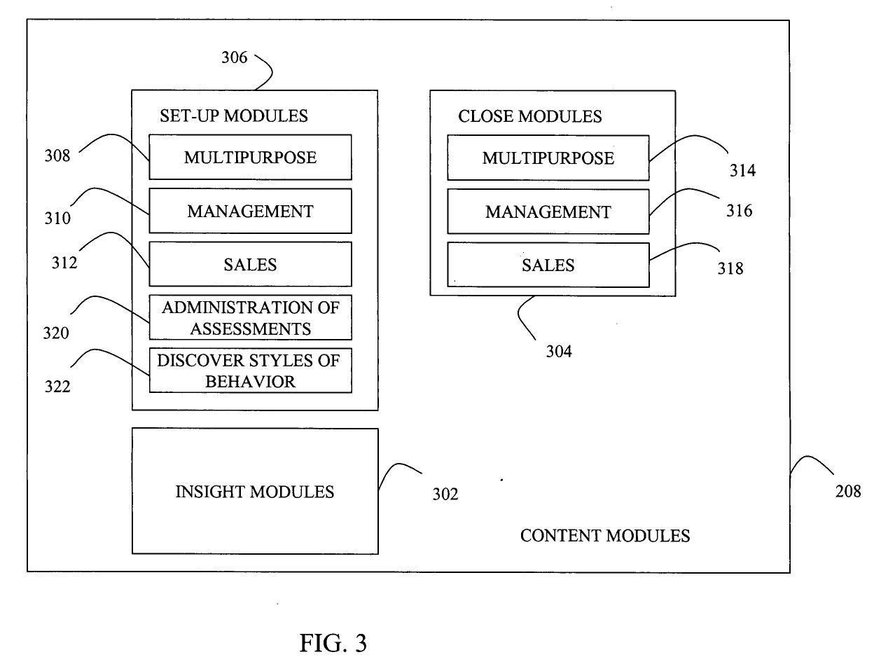

FIG. 3 is a block diagram illustrating one embodiment of the content module library 208 shown in FIG. 2. In this embodiment, content module library 208 comprises a set-up modules library 306, a close modules library 304, and an insight modules library 302. The insight modules library 302 is described in further detail below.

The content modules are components that are central to the development of most seminars. They contain material that directly explains to a facilitator how to present a particular topic in a particular session. This explanation is provided both at a high level and at a more concrete level. At a high level, each content module has a suggested time for its presentation, a general content description, a statement of goals and a quick reference guide that defines the three or four most significant points for one or more application-specific variations of the module. At a more concrete level, for each application-specific variation, the content module includes a script with exact words for what the facilitator may say and do, including explaining, instructing and asking, almost like a screenplay. This script may also include cues and pointers to use specific visual or audiovisual presentation materials or to direct individual or group activity, often with associated handout materials, at particular points in time. These materials included in the content modules are specifically identified so that they can be found in and pulled from the multimedia sub-library 210 or the alternative activities library 204 or any other resource library provided in the database 110 and/or library 202. Thus, the facilitator has cues to guide presentation of slides or audiovisual content at the right time during the session defined by a content module and may create handouts in appropriate numbers to be provided at the start of or during the session defined by the content module.

If the course will not be delivered in a live-seminar format, the content modules providing a facilitator script can be used to produce a video presentation, or a sequence of screens for computer display, or pages for a paper course book with essentially the same content as a facilitator-delivered seminar.

Set-up modules library 306 includes but is not limited to a multipurpose set-up module 308, a management set-up module 310, and a sales set-up module 312. Also included are two further modules: an optional administration of assessments module 320 and a discover styles of behavior module 322.

Multipurpose set-up module 308 is used as an introduction to the curriculum and is applicable to all types of individuals and groups. In one embodiment, multipurpose set-up module 308 is partly textual in format and is supplemented by multimedia from multimedia library 210 as well as alternative activities from alternative activities library 204.

Management set-up module 310 is used as an introduction to the courses on this application and generally focuses on skills and knowledge from a DISC viewpoint of particular interest to managers in general. In one embodiment, management set-up module 310 is partly textual in format and is supplemented by multimedia from multimedia library 210 as well as alternative activities from alternative activities library 204.

Sales set-up module 312 is used as an introduction to the curriculum and generally focuses on skills and knowledge from a DISC viewpoint of particular interest to sales people in general. In one embodiment, sales set-up module 312 is primarily textual in format and is supplemented by multimedia from multimedia library 210 as well as alternative activities from alternative activities library 204.

Administration of assessments module 320 is optional, for use when an assessment will be administered to persons participating in training. There are two basic modes of assessment delivery. If a paper assessment is used, this module describes the instrument and its use, including instructions on delivering and general information on interpreting responses. If an electronic assessment is used, this module describes the computer-based (including online) access to instruments and subsequent interpretation, as well as distribution of and/or access to results. Discover style of behavior module 322 is in one embodiment a fundamental statement of the DISC psychological constructs and theory and thus a fundamental part of most applications. It helps trainees understand behavior styles and explore the preferences associated with a particular style. In courses attended by previous attendees, it might be used in abbreviated form.

Close modules library 304 includes but is not limited to a multipurpose close module 314, a management close module 316, and a sales close module 318. Use of a close module from the close modules library 304 is generally recommended for a training application, to summarize and reinforce learning. In one embodiment, multipurpose close module 314 is used when multipurpose set-up module 308 is selected. In one embodiment, management close module 316 is used when management set-up module 310 also is selected. In one embodiment, sales close module 318 is used when sales set-up module 312 is selected.

Multipurpose close module 314 is used as a closing to the curriculum and is applicable to all types of individuals and groups. Management close module 316 is used as a closing to the curriculum and generally focuses on aspects of particular interest to managers in general. Sales close module 318 is used as a closing to the curriculum and generally focuses on aspects of particular interest to sales people in general. In one embodiment, each of the close modules 314, 316 and 318 is partially textual in format and may be supplemented by multimedia from multimedia library 210 as well as alternative activities from alternative activities library 204.

In one embodiment, one or more of the set up modules 306 or close modules 304 may have associated multimedia content, as explained in greater detail with respect to the insight modules 302.

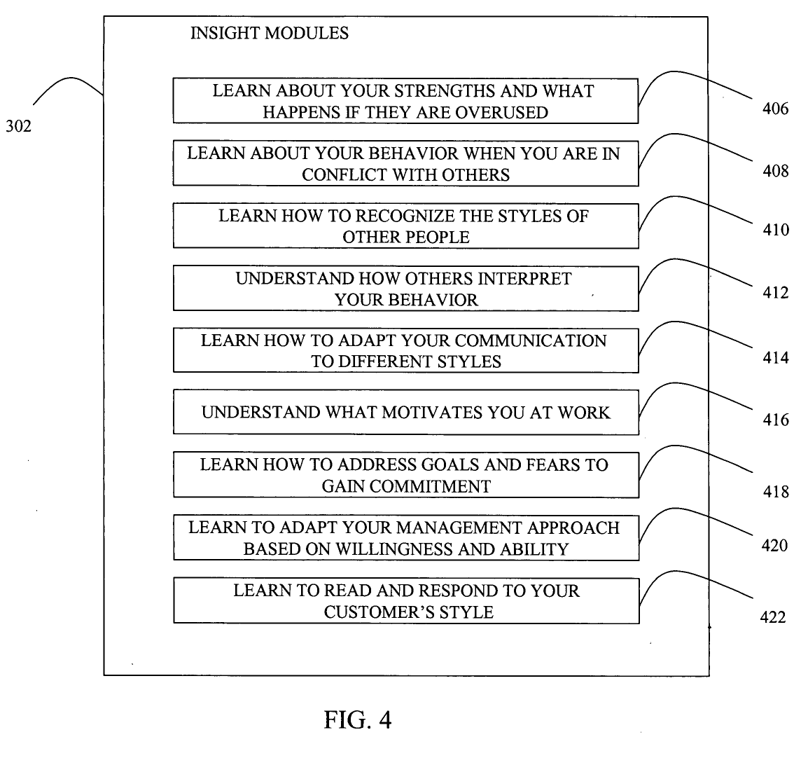

FIG. 4 is a block diagram illustrating one embodiment of the insight modules library 302 shown in FIG. 3. In this embodiment, insight modules library 302 includes but is not limited to the following modules:

a “learn about your strengths and what happens if they are overused” module 406,

a “learn about your behavior when you are in conflict with others” module 408,

a “learn how to recognize the styles of other people” module 410,

an “understand how others interpret your behavior” module 412,

a “learn how to adapt your communication to different styles” module 414,

an “understand what motivates you at work” module 416,

a “learn how to address goals and fears to gain commitment” module 418,

a “learn to adapt your management approach based on willingness and ability” module 420, and

a “learn to read and respond to your customer's style” module 422.

Insight modules 406, 408, 410, 412, 414, 416, 418, 420 and 422 are sequence independent, and when more than one is useful to an application can be implemented in learning materials for that application in any order that is effective for a desired application. Each of the modules 406, 408, 410, 412, 414, 416, 418, 420 and 422 has its own distinct DISC insight on a particular topic that allows it to be used independently of all others. Each of the modules 406, 408, 410, 412, 414, 416, 418, 420 and 422 has a suggested session duration, a brief description of the module, and a quick reference that shows a facilitator what the module delivers, step by step. In one embodiment, modules 406, 408, 410, 412, 414, 416, 418, 420 and 422 have associated multimedia content elements, which are referenced in or linked to the module, so that it becomes part of the learning materials generated as a result of inclusion of the module in a course. Thus, these modules may include a list of or links or pointers to handouts, PowerPoint® slides (or other electronic display images) and other required visual presentation materials for each step. They may also include notes to the facilitator throughout the module, a script for the facilitator, and individual, partner, and group activities for training participants.

In one embodiment, the handouts and PowerPoint® slides or other multimedia content elements needed for the insight modules 406, 408, 410, 412, 414, 416, 418, 420 and 422 are contained in the multimedia library 210. The lists, links or pointers in selected insight modules are then used to incorporate this content (directly or indirectly) into learning materials in a manner that permits the content to be presented or referenced at the appropriate point during training. In one embodiment, the individual, partner, and group activities that are optional or replacement activities are contained in the alternative activities library 204. In one embodiment, behavior modules 406, 408, 410, 412, 414, 416, 418, 420 and 422 are adapted to be used in conjunction with a psychological profile created by the administration of DiSC classic paper assessment or its electronic equivalent as set up by use of the administration of assessment module 320.

The insight modules are prepared to work across a wide variety of training applications. In some applications, it will add value for trainees to tie the insight material content more closely to a particular application. Thus, an insight module can be prepared with one or more focus cues. These direct a facilitator to shape the learning experience toward the application. The following is an example of a set of focus cues included in an insight module in the form of discussion suggestions to guide the instruction toward one of four different applications: (a) Team application: ask partners to discuss the value they bring to the team; (b) Management application: ask partners to discuss the value they bring to the role of manager; (c) Communication application: ask partners to discuss the value they bring when communicating with others; and (d) Sales application: ask partners to discuss the value they bring to their selling relationships. The focus cues need not lead solely to discussion. They could also lead to an application-specific individual or group activity. The cues provide an opportunity to adjust the learning experience by making a closer connection to the particulars of an application.

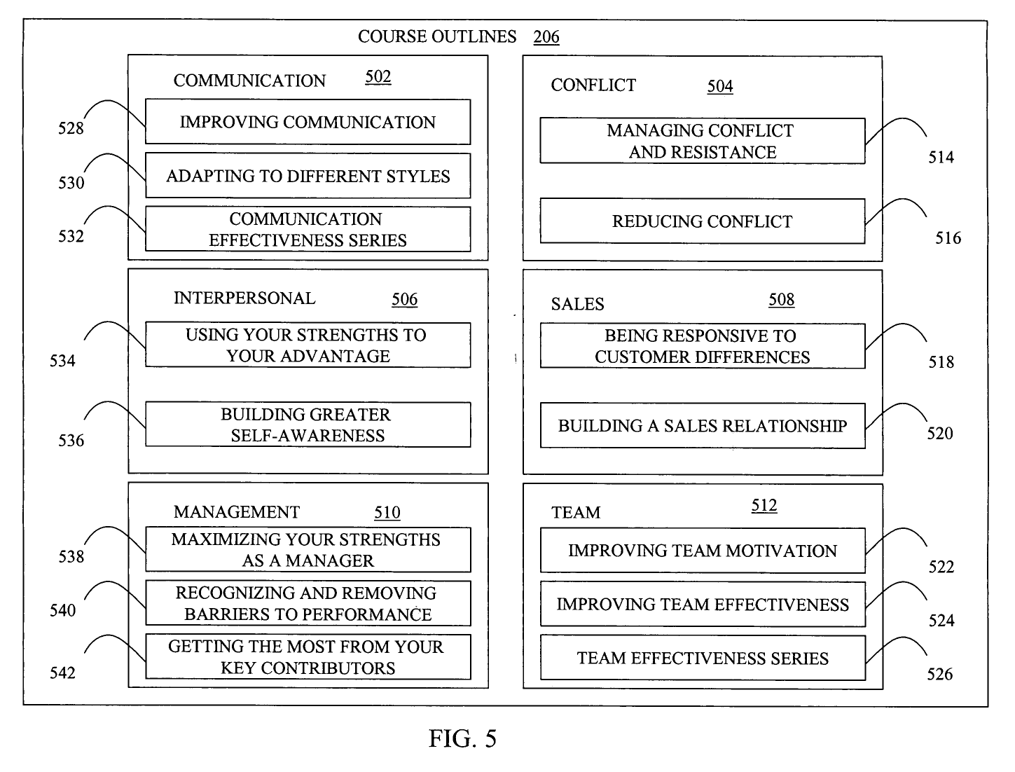

FIG. 5 is a block diagram illustrating one embodiment of the course outlines library 206 shown in FIG. 2. The course outlines are pre-designed for particular training applications. They are useful as actual outlines for a facilitator to adopt and also as examples for how a facilitator might build a course of his or her own, using the modules and components in the libraries. In this embodiment, course outlines library 206 includes but is not limited to a communication outline sub-library 502, a conflict outline sub-library 504, an interpersonal outline sub-library 506, a sales outline sub-library 508, a management outline sub-library 510, and a team outline sub-library 512.

Communication outline sub-library 502 includes but is not limited to an improving communication outline 528, an adapting to different styles outline 530, and a communication effectiveness series outline 532. Communication outlines from the communication outline sub-library 502 are ready-to-use outlines that have a particular focus on the topic of communication. The communication outlines in the communication outline sub-library 502 have varying lengths and applications and provide facilitators/instructors the opportunity to get familiar with the structure of the sub-libraries before using them to design their own learning materials.

Conflict outline sub-library 504 includes but is not limited to a managing conflict and resistance outline 514 and a reducing conflict outline 516. Conflict outlines from the conflict outline sub-library 504 are ready-to-use outlines that have a particular focus on the topic of conflict. The conflict outlines in the conflict outline sub-library 504 have varying lengths and applications and provide facilitators/instructors the opportunity to get familiar with the structure of the sub-libraries before using them to design their own learning materials.

Interpersonal outline sub-library 506 includes but is not limited to a using your strengths to your advantage outline 534 and a building greater self-awareness outline 536. Interpersonal outlines from the interpersonal outline sub-library 506 are ready-to-use outlines that have a particular focus on the topic of interpersonal traits. The interpersonal outlines in the interpersonal outline sub-library 506 have varying lengths and applications and provide facilitators/instructors the opportunity to get familiar with the structure of the sub-libraries before using them to design their own learning materials.

Sales outline sub-library 508 includes but is not limited to a being responsive to customer differences outline 518 and a building a sales relationship outline 520. Sales outlines from the sales outline sub-library 508 are ready-to-use outlines that have a particular focus on the topic of sales. The sales outlines in the sales outline sub-library 508 have varying lengths and applications and provide facilitators/instructors the opportunity to get familiar with the structure of the sub-libraries before using them to design their own learning materials.

Management outline sub-library 510 includes but is not limited to a maximizing your strengths as a manager outline 538, a recognizing and removing barriers to performance outline 540 and a getting the most from your key contributors outline 542. Management outlines from the management outline sub-library 510 are ready-to-use outlines that have a particular focus on the topic of management. The management outlines in the management outline sub-library 510 have varying lengths and applications and provide facilitators/instructors the opportunity to get familiar with the structure of the sub-libraries before using them to design their own learning materials.

Team outline sub-library 512 includes but is not limited to an improving team motivation outline 522, an improving team effectiveness outline 524 and a team effectiveness series outline 526. Team outlines from the team outline library sub-512 are ready-to-use outlines that have a particular focus on the topic of working as a team. The team outlines in the team outline sub-library 512 have varying lengths and applications and provide facilitators/instructors the opportunity to get familiar with the structure of the sub-libraries before using them to design their own learning materials.

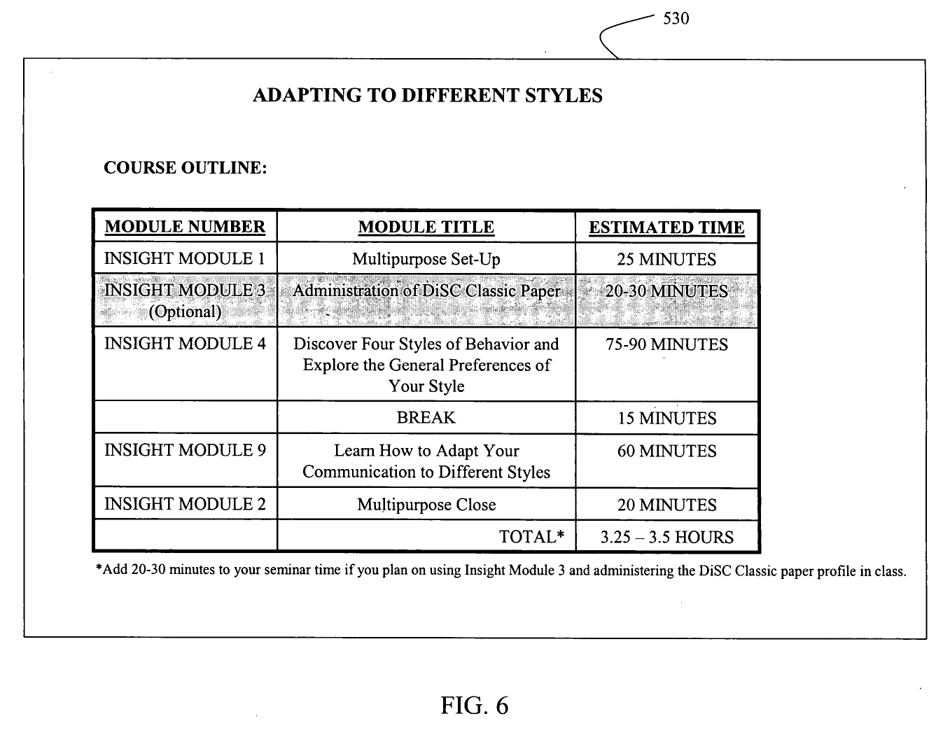

By way of example, FIG. 6 is one embodiment of the adapting to different styles course outline 530 shown in FIG. 5. In this embodiment, the adapting to different styles outline 530 incorporates four content modules and one optional module all of varying length. The first module, is the multipurpose set-up module (e.g., module 308) which lasts approximately twenty-five minutes. After the multipurpose set-up module, an optional module titled administration of DiSC classic paper module (e.g., module 320) is used, which lasts approximately twenty to thirty minutes. Following the administration of DiSC classic paper module, a discover four styles of behavior and explore the general preferences of your style module (e.g., style module 322) is used which lasts approximately seventy five to ninety minutes. The course outline then has a break of fifteen minutes scheduled.

After the break, two more modules follow. The first module after the break is the learn how to adapt your communication to different styles module (e.g., module 414) which lasts approximately one hour. After the learn how to adapt your communication to different styles module is the multipurpose close module (e.g., insight module 314), which lasts approximately twenty minutes. This ends the training session, and the training session in its entirety lasts approximately three and a quarter to three and one half hours. In one embodiment, to address a different application, any of the other insight modules from the insight modules library 302 could proceed or follow the learn how to adapt your communication to different styles module 414. Furthermore, modules from the multimedia library 210 and the alternative activities library 204 are adapted to supplement or replace portions of the learning materials.

Use of outlines from the course outline library 206 are optional in creating learning materials, and instead learning materials can be created through the selection of various set-up modules from set-up module library 306, close modules from close module library 304 and insight modules from insight module library 302. When a facilitator wants to use the present system to prepare learning materials, existing course outlines and the content they point to can be accessed for review via computer system 100. If this review does not lead to selection of one of the suggested course outlines, then the facilitator, accessing the system 100 via one of the personal computers 116-1, 116-2, . . . 116-S is guided through a selection process. The outcome of the process will be a set of learning materials components that will provide a course script, a listing of slides and other presentation materials to be offered on a screen, a listing of handouts to be delivered to participants and any supporting supplies for the facilitator and/or the participants. If a user defines a new course outline and assembles from the database 110 the learning materials to deliver the application for which the new course outline was developed, the system 100 permits the new outline and corresponding learning materials to be stored in the database 110 under an appropriate title for future reference and for regeneration of the learning materials.

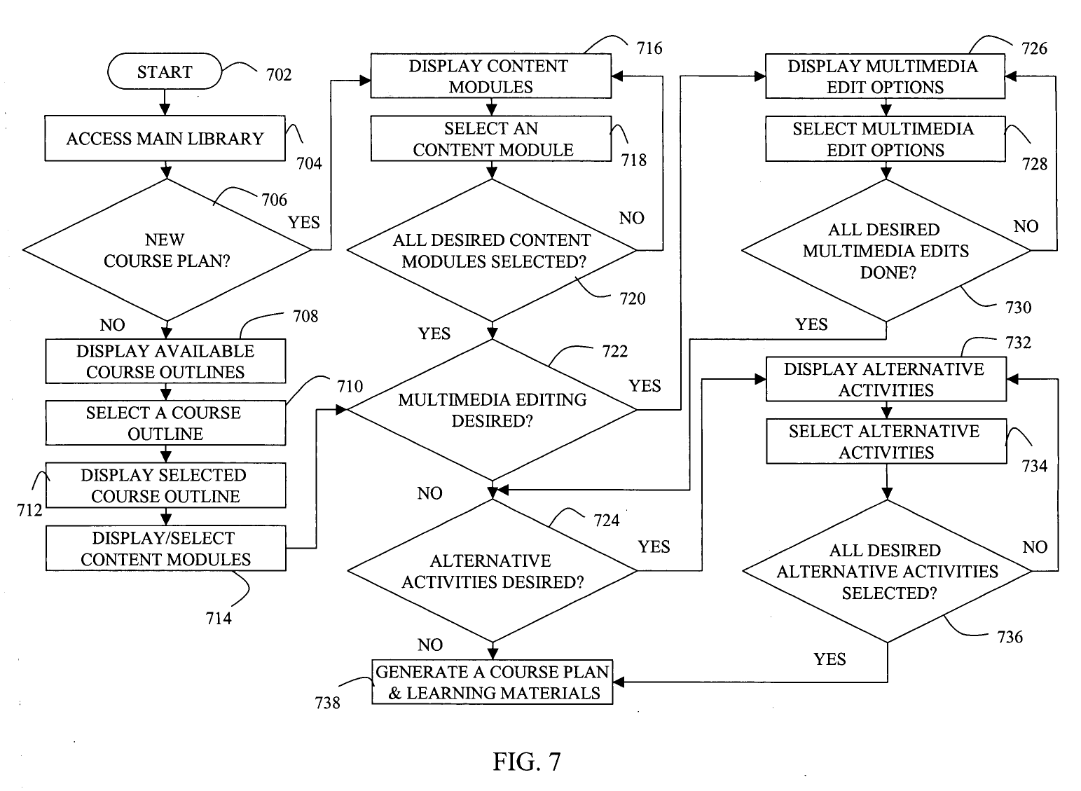

Building Course and Leaming Materials. FIG. 7 is a flowchart illustrating one embodiment of a method of developing a curriculum in accordance with the present invention. The method of developing a curriculum starts at 702. The contents of a main library are accessed (704). In one embodiment the main library is substantially similar to main library 202 and includes a multimedia library 210, a content modules library 208, a course outlines library 206 and an alternative activities library 204.

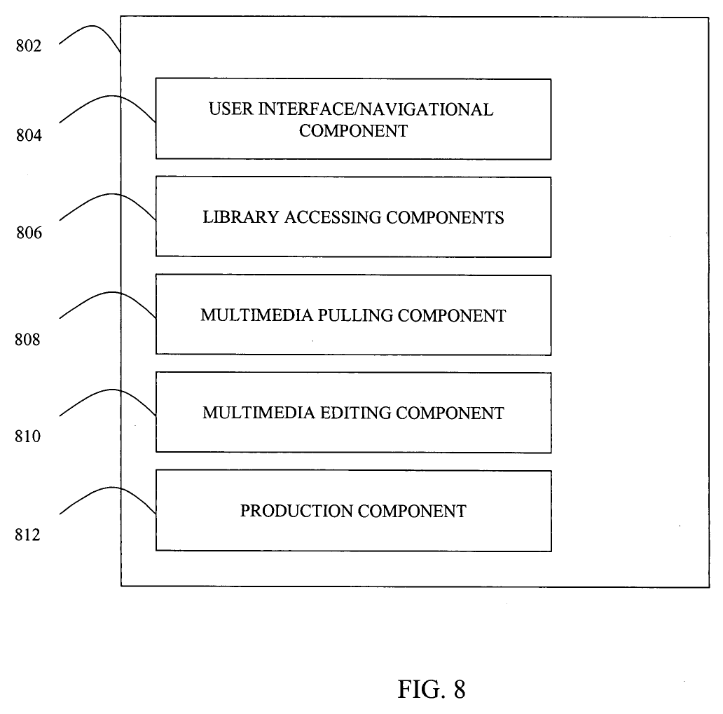

The software components shown in FIG. 8 provide the user interfaces and accept the user selections and other inputs; that is, by menus and other interface features these components control the user's navigation to make selections from libraries to create learning materials. They also implement editing controls so that portions of the content library material that from the publisher's viewpoint are essential for quality control can be made unavailable for editing, at least to those users of the system that require further education or experience. Such limits on editing selectively make available for editing certain portions of the materials that are in the libraries and may make unavailable entire documents or may allow editing of only certain fields that do not affect the substance of materials carefully prepared by the publisher.

The user determines if he/she wants to create a new course plan with learning materials or to use a pre-existing one (706), i.e., one already in a library. If the user does not want to create a new course, the available course outlines are displayed (708). The user selects one or more of the available course outlines that meets the user's needs (710). The selected course outlines are displayed to the user (712). The content modules associated with the particular course outline selected are displayed for the user to review and use (714).

If the user determines that he/she wants to create his/her own course the available content modules are displayed (716). The user selects one or more of the content modules from the available libraries of modules (718). As part of selection, the menu of insight modules in insight module library 302 will be offered. As noted above, the selections here are from sequence independent modules. There are no prerequisite linkages that limit the user choice within this library. There may be linkages for content modules outside of the insight modules library 302. These constraints can be implemented in the selection menus offered, so that the user is guided only to predetermined components. The user determines if all of the desired content modules are selected that are needed to create the learning materials for the training application (720). If the user realizes that he/she needs additional content modules, the content modules are displayed again (716) and the user selects zero, one or more additional content modules (718).

The content modules have associated multimedia. In some applications, the user will want to edit the multimedia, e.g., slide content, to shape it for a particular application or training group. For example, particular company or department names or company logos could be inserted in slides. At step 722, the user determines if such editing is desired. If no editing of multimedia is desired, then the user proceeds to determine if any alterative activities are desired to be included in the learning materials (724).

If alternative activities are not desired to be included in the curriculum, the course plan and associated learning materials desired by the user are generated (738).

If editing of multimedia is desired, the available multimedia editing options are displayed. (726) For quality control purposes, the editing may be subject to limitations, i.e., not all content will be editable, rather only certain fields or pages. Also, the system may allowing editing of slides but not allow editing of audiovisual content or other content that requires more sophisticated tools to perform quality editing. The user will select one of more of the multimedia editing options (728). The user then determines if all desired multimedia editing has been selected and performed (730). If the user wants to select additional multimedia editing, then the multimedia editing options are again displayed (726) and the user selects from among them (728). Upon completion of multimedia editing, the user determines if alternative activities are desired to be included in the course plan and associated learning materials (724). If alternative activities are not desired to be included in the course plan and associated learning materials, the course plan and associated learning materials desired by the user and defined by the preceding selections are generated (738).

If the user determines that alternative activities may be desired, the available alternative activities are displayed (732). The user selects zero, one or more alternative activities that the user desires for his curriculum (734). The user determines if all of the desired alternative activities have been selected (736). If the user wants to select additional alternative activities, the available alternative activities are displayed again (732) and the user selects zero, one or more additional alternative activities (734).

If the user determines that all of the desired alternative activities are selected, the course plan and associated learning materials desired by the user and defined by the preceding selections are generated (738). If additional course plan and associated learning materials for another application are desired by the user, the method starts again at 702.

Permissions Management. If all material in the database 10 that is selectable for learning materials is owned by the operator of the system 100, then the generation and copying of learning materials can proceed without concern about reproduction or distribution rights. In some instances a particular item of text, such as a dialog or a particular image or a segment of audiovisual material will be available in the database but perhaps subject to use constraints or royalty payments. By flagging such material, the constraints can be respected. The navigational interface for users can be configured to prevent selection by simply not offering the content in a menu or by offering it and noting the permission and/or royalty required. The system could further be configured to determine the usage level and actually initiate documentation and/or payment for permissions. The system could also be configured to generate required credit notices where those are needed in certain forms of publication for permissioned material that will appear in learning materials.

Assessment Management. The psychological theoretical underpinnings of the learning materials make it useful for some applications to have participants complete one or more psychological assessments. These provide data that can be useful to the learning experience in various ways. In one mode, the assessment is a self assessment and is administered so that only the assessed participant is aware of the results, but can participate in the course with that knowledge. In another embodiment, the assessment is a self assessment and is administered so that the facilitator is aware of the results as well as the assessed participant. In some instances it is useful to have the facilitator aware of the results in advance of the seminar and in advance of the participant learning them. In another embodiment, the assessment results are shared within a group of participants, usually also with the facilitator. This is particular useful for team-oriented seminars. The sharing may be general or within defined subsets of the participants, such as teams.

The assessments may be administered using paper documents, in which case the first embodiment is easily implemented, as the assessed individual can be led to understand the assessment results and need not share those with any other person. The computer system 100 can also be used to administer assessments, which are delivered online. The personal computers 116-1, 116-2, . . . 116-S can be used to notify a person of the opportunity or requirement of the assessment (e.g., by e-mail) and to guide a person through an assessment process for one or more assessment instruments. Such activities can be under the supervision of the administration of assessment module 320 to provide communications, presentation of instruments, collection of responses, scoring/interpretation, logging of completion and communication of results (in coordination with e-mail list management software on the system 100 and existing websites that provide browser access to assessment instruments).

Here, again the results can be provided only to the assessed individual before or during a seminar. However, once the results have been developed by computer-based administration, there are other options. The results can be shared electronically (or in a printed report) with the facilitator, before or simultaneous with the assessed person getting results. The results also can be shared electronically (or in a printed report) with the facilitator and a seminar group. The results can be analyzed with comparisons and with group interactions being assessed based on the results and the psychological theories with respect to the interactions of persons having specific profiles as determined by the various assessment. Interjection of that information into a course can be particularly useful and becomes possible once the assessment information is in a database. A further result is that value-added interpretative analyses may be performed on an individual or group interaction basis, again based on the results and the psychological theories with respect to the interactions of persons having specific profiles as determined by the various assessment. These results, too, can become part of a course with appropriate design of the reports. A still further result of the computer-based administration is that a database of assessment data can be developed that may be useful in validation studies, although these are usually not introduced in the course of most training.

Alternative Applications. Although the above example speaks in terms of the DISC theory and use of assessment instruments as part of the learning materials generated by the system 100, the system may also be useful to generate learning materials for other subject matters. Sequence independent insight modules can also be used in training applications that do not require the use of assessments as a part of the learning process. For example, they could easily be applied to the competency model learning environments which are prevalent today. In this instance, the insight modules can be sub-divided into the elemental personal and organizational insights that relate to a given competency. As with the DISC implementation discussed above, the sequence independent insight modules for each competency can be combined in numerous permutations to suit a wide variety of learning objectives and applications for a given competency. Furthermore, by creating an extensive library of insight modules relating to competencies sub-divided in this way, the insight modules from multiple competencies could be combined to readily create permutations of competencies themselves. This process can dramatically accelerate the rate at which learning materials can be developed for competency based environments.

Curriculum Development Software System. FIG. 8 is a block diagram illustrating a curriculum development software system that may be used to implement the method for developing learning materials in accordance with the present invention. The curriculum development system software may reside in a memory 802. In one embodiment, memory 802 is as described with respect to memory 102 shown in FIG. 1. In another embodiment, memory 802 is as described with respect to database 110 shown in FIG. 1. Memory 802 stores several software components that provide navigation, processing and other controls for executing the method shown in FIG. 7 including: a user interface/navigational component 804, library accessing components 806, a multimedia pulling component 808, a multimedia editing component 810, and a production component 812.

Language Selection. The present system may be used in circumstances where all or portions of a course developed using it may be offered in different languages. Thus, the basic libraries (see FIGS. 2-5), having been authored in one language, such as English, are translated into other languages to make further libraries that meet the needs of multinational organizations that wish to have uniform training across geographical locations and may have training sessions in which persons having different native languages participate. One particular dimension of this involves the assessment instruments and materials that discuss their results. Research has shown that DISC and other similar assessments based on personal descriptors need to be developed and validated for each language group. Direct word translations from original assessment instruments may not be available, and in any event need to be tested on applicable populations. Because the usefulness of assessments is highly dependent on the terminology used, it may be desirable to have assessments provided in a native language, even if training materials can otherwise be in English or some other language commonly understood by the trainees.

The system is designed to permit language selection at at least two levels. First, referring again to FIG. 7, when a user accesses a main library (704), the user can choose to access available libraries in English, French, German, Greek, etc. With this initial selection, further course development can continue using only the modules translated into the selected language. Second, the user can proceed for course development using a common instructional language, such as English, but then provide that any assessments that become part of the course, are provided in and results discussed in a trainee native language. The menus presented for content selection and for editing (e.g., 718, 722) can provide flexibility to provide assessments in native languages, and to the extent necessary have corresponding training materials edited so that culturally sensitive and accurate communication occurs. As needed, the administration of assessments module 320 can be provided with configuration options that control delivery of assessments and any results in the desired language for particular trainees.

Although embodiments of this invention have been described above with a certain degree of particularity, those skilled in the art could make numerous alterations to the disclosed embodiments without departing from the spirit or scope of this invention. All joinder references (e.g., attached, coupled, connected, and the like) are to be construed broadly and may include intermediate elements between a connection of elements. As such, joinder references do not necessarily infer that two elements are directly connected and in fixed relation to each other and are only used for identification purposes to aid the reader's understanding of the embodiments of the present invention, and do not create limitations, particularly as to the position, orientation, or use of the invention unless specifically set forth in the claims.

In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

We claim:

1. A method for developing a training curriculum from a pre-existing library of materials, comprising:
controlling selection of at least one set-up module from the pre-existing library;
controlling selection of at least one closing module from the pre-existing library;
controlling selection of at least one insight module from the pre-existing library, wherein each insight module is sequence independent of the others; and
combining the set-up, closing and insight modules into a predefined set of learning materials.

2. The method of claim 1 wherein one or more of the modules selected from the pre-existing library has associated multimedia content and the step of combining the set-up, closing, and insight modules, and multimedia content into learning materials comprises incorporation of the associated multimedia content directly or by link.

3. The method of claim 1 further comprising:
selecting at least one alternative activities option from the pre-existing library;
and wherein the step of combining comprises combining the set-up, closing, and insight modules, and alternative activities option into learning materials.

4. The method of claim 2 further comprising:
selecting at least one alternative activity from the pre-existing library; and wherein the step of combining comprises
combining the set-up, closing, and insight modules, multimedia content and alternative activities into learning materials.

5. The method of claim 1 wherein at least one module in the learning materials calls for assessing the psychological profile of an individual participating in the training.

6. The method of claim 5 wherein the at least one insight module is adapted to be used in conjunction with a psychological profile called for by the least one module of the learning materials.

7. The method of claim 1 wherein one or more of the at least one set-up module, the at least one closing module and the at least one insight module has multiple focus cues for specific applications.

8. The method of claim 1, wherein at least one module selected calls for participants to complete a psychological assessment.

9. The method of claim 8, wherein the psychological assessment is delivered online.

10. The method of claim 8, wherein the psychological assessment is delivered online and the results are distributed to the facilitator for use with learning materials.

11. The method of claim 8, wherein the psychological assessment results are distributed to training participants for use with the learning materials.

12. The method of claim 8, wherein the psychological assessment results are distributed to training participants, with each participant receiving only his/her own assessment for use with the training materials.

13. The method of claim 8, wherein the psychological assessment results are distributed to training participants, with each participant receiving his/her own assessment as well as the assessment of at least one other participant for use with the training materials.

14. The method of claim 8, wherein the psychological assessment results are distributed to training participants, with each participant receiving his/her own assessment and an analysis of behavioral interactions based on an assessment of at least one other participant for use with the training materials.

15. The method of claim 1, wherein one or more of the modules selected from the pre-existing library has associated multimedia content and the step of combining the set-up, closing, and insight modules, and multimedia content into learning materials comprises editing of the associated multimedia content and incorporation of the associated edited multimedia content directly or by link.

16. The method of claim 1 further comprising presenting a language selection option and making available for selection in a pre-existing library modules in a selected language, to produce training materials using that language.

17. The method of claim 1 further comprising presenting a user interface for an administration of assessment module and from such user interface controlling selection of assessments to provide them in a native language of a trainee.

18. A computer readable medium having stored therein a computer program for developing a training curriculum from a pre-existing library of materials, comprising:
a component for controlling selection of at least one set-up module from the pre-existing library;
a component for controlling selection of at least one closing module from the pre-existing library;
a component for controlling selection of at least one insight module from the pre-existing library, wherein each insight module is sequence independent of the others; and
a component for combining the set-up, closing and insight modules into a set of learning materials.

19. The computer readable medium of claim 18, wherein one or more of the modules selected from the pre-existing library has associated multimedia content and the step of combining the set-up, closing, and insight modules, and
multimedia content into learning materials comprises incorporation of the associated multimedia content directly or by link.

20. The computer readable medium of claim 18, wherein one or more of the modules selected from the pre-existing library has associated multimedia content and the step of combining the set-up, closing, and insight modules, and multimedia content into learning materials comprises editing of the of the associated multimedia content and incorporation of the associated multimedia content directly or by link.

21. A method for developing a training curriculum from a pre-existing library of materials, comprising:
accessing the pre-existing library;
determining if a new course or an existing course is desired;
if a new course is desired, selecting at least one insight module, wherein each insight module is sequence independent of the others;
determining if at least one alternative activities option is desired;
if at least one alternative activities option is desired, selecting the at least one alternative activities option; and
generating learning materials including the selected at least one insight and alternative activities option modules.

22. A system for developing a training curriculum comprising:
a memory adapted to store a computer software comprising:
a user interface/navigational component;
at least one library accessing component for accessing and selecting content modules;
a multimedia pulling component, responsive to associations between selected content modules and the multimedia content;
a multimedia editing component; and
a production component for combining selected content modules and any edited multimedia content into learning materials.

23. The system of claim 22 wherein the multimedia editing component selectively allows or blocks editing of multimedia content.

24. The system of claim 22, further comprising a content module editing component, wherein the content editing module selectively makes unavailable entire documents in content modules or allows editing of only certain fields in such documents.
